(19) United States
(12) Patent Application Publication
(10) Pub. No.: US 2015/0360060 A1
(43) Pub. Date: Dec. 17, 2015

(54) CARRYING SYSTEM FOR A BLOWER FILTER DEVICE, BLOWER FILTER DEVICE AS WELL AS BLOWER FILTER SYSTEM

(71) Applicant: DRÄGER SAFETY AG & CO. KGaA, Lübeck (DE)

(72) Inventors: Mathias DEHMKE, Lübeck (DE); Mirco FRÖSCH, Stockelsdorf (DE); Simone HOHENBERGER, Lingen (DE); Stefan FREYHER, Selmsdorf (DE); Horst WERGEN, Köln (DE)

(21) Appl. No.: 14/761,383

(22) PCT Filed: Jan. 16, 2014
(86) PCT No.: PCT/EP2014/000112

§ 371 Date: Jul. 16, 2015

(30) Foreign Application Priority Data
Jan. 17, 2013 (DE) 10 2013 000 809.3

(51) Int. Cl. A62B 9/04; A62B 7/10; B01D 46/00

(52) U.S. Cl. CPC A62B 9/04; B01D 46/0002; A62B 7/10

(57) ABSTRACT

A support system (1) for a fan filter device (20) of a fan filter system (30) has a base strap (2) for arranging the support system on the body (40) of a user and has a securing system (3) on the base strap for securing the fan filter device in a first position (4) and in at least one different second position (5) on the base strap. The securing system has a guide element (6), secured to the base strap, to retain the fan filter device in the different positions (4, 5). The securing system has a counter-guide element (10), movably guided on the guide element via at least one guide gap (11), that has at least one securing element (12) for securing the counter-guide element on the fan filter device. A fan filter device for a fan filter system and a fan filter system are also provided.

### CROSS REFERENCE TO RELATED APPLICATIONS

This application is a United States National Phase Application of International Application PCT/EP2014/000112 filed Jan. 16, 2014 and claims the benefit of priority under 35 U.S.C. §119 of German Patent Application DE 10 2013 000 809.3 filed Jan. 17, 2013, the entire contents of which are incorporated herein by reference.

### FIELD OF THE INVENTION

The present invention pertains to a carrying system for a blower filter device of a blower filter system, having a base strap for arranging the carrying system on the body of a user as well as a securing system on the base strap for securing the blower filter device in a first position and in at least one second position on the base strap, wherein the second position is different from the first position, wherein the securing system has a guide element, which is secured to the base strap, wherein the guide element is designed to retain the blower filter device in the different positions. Further, the present invention pertains to a blower filter device for a blower filter system as well as to a blower filter system.

### BACKGROUND OF THE INVENTION

Blower filter systems are generally known. Blower filter systems are used for light and medium respiration protection and support the user of respirator filters by lowering the respiration resistance, contrary to conventional breathing masks and thus make long-term. fatigue-free use possible. A blower filter system comprises the following principal components: A blower filter device, usually worn on a belt, and a headpiece, which is preferably designed as a hood, helmet or mask. These two components are connected with one another via a flexible tube. The contaminated air is drawn in through a filter by means of the blower filter device, as result of which it is freed from harmful substances, and the purified air is subsequently sent to the headpiece via the flexible tube and is fed to the user of the respirator.

The purpose of carrying systems for blower filter systems is, in principle, to retain the blower filter device or the filter unit in its desired position in a stable manner and securely. The selection of the desired carrying system and, as a result, also the position on the body are determined here by the intended use. The carrying position is predominantly on the back of user in the area of the lumbar spine. However, the operation of the blower filter device and hence of the blower filter system is possible only with difficulty due to this position. Button elements can only be detected by touch, and it is almost impossible to read the remaining battery capacity of the blower filter device or the filter load level. A blower filter device in a fixed position may get in the way, causing a very great problem, in poorly accessible workplaces.

### SUMMARY OF THE INVENTION

An object of the present invention is to at least partially eliminate the above-described drawbacks in an above-described blower filter system. In particular, it is an object of the present invention to provide a carrying system for a blower filter device of a blower filter system, a blower filter device for a blower filter system as well as a blower filter system, which make great flexibility possible in handling the blower filter system in a cost-effective and simple manner.

Features and details that are described in connection with the carrying system according to the present invention are, of course, also applicable in connection with the blower filter device according to the present invention and the blower filter system according to the present invention and vice versa in each case, so that reference is or can always mutually be made to the individual aspects of the present invention concerning the disclosure.

According to a first aspect of the present invention, the object is accomplished by a carrying system for a blower filter device of a blower filter system, having a base strap for arranging the carrying system on the body of a user as well as a securing system on the base strap for securing the blower filter device on the base strap in a first position and in at least one second position, wherein the second position is different from the first position, wherein the securing system has a guide element, which is secured to the base strap, wherein the guide element is designed to retain the blower filter device in the different positions. The carrying system is characterized in that the securing system has a counter-guide element, which is guided displaceably on the guide element via at least one guide gap, and that the counter-guide element has at least one securing system for securing the counter-guide element on the blower filter device.

A carrying system designed in this manner for a blower filter device of a blower filter system makes it possible to change the position of the blower filter device on the carrying system in a cost-effective and simple manner and increases, as a result, the flexibility of the blower filter system in terms of handling. The securing system of the carrying system makes it possible that the blower filter device can be moved between at least two and preferably between more than two positions relative to the base strap. Depending on the application by a user of the blower filter system, the user can change the position of the blower filter device on the base strap of the carrying system, as a result of which the handling or use of the blower filter system is markedly facilitated for the user. The base strap of the carrying system is preferably seated in a fixed and defined position on the body of the user. The securing system of the carrying system makes it possible to arrange the blower filter device of a blower filter system in different positions on the carrying system as desired. In normal use, a blower filter device can be arranged, as in the case of usual carrying systems, on the back of a user in the area of the lumbar spine. However, operation of the blower filter device is difficult in this first position, because the user of the blower filter system can only detect operating elements by touch without being able to see them. Due to the fact that the user can move the blower filter device into a second position, which is different from the first position, via the securing system of the carrying system, it is possible for him to see the blower filter device and to operate it with greater ease. The position of the blower filter device on the base strap of the carrying system is preferably effected manually, i.e., if it is desired to change the position of the blower filter device, the user can move the blower filter device manually into a second position, preferably a position on the side of the body of the user. The motion back into the first position is preferably likewise effected manually. The function of changing the position, also called railing function, can advantageously be performed during the current operation of the blower filter device as well as when the operation of the blower filter device is stopped.

As was already suggested, a plurality of advantages arise over the prior-art carrying system, which make it possible to arrange a blower filter device on a carrying system in only one position. A blower filter device can be moved forward for better operation from a rear position into a lateral or front position. In narrow passageways or when using the blower filter system in the dorsal position, the user can move the blower filter device and position it on the carrying system in a position that is favorable for him. The hindrance caused by the blower filter device can be minimized hereby. Further, the user's clothing is spared by the use of such a carrying system. This means that the user's clothing can be spared by displacing the blower filter device instead of displacing the entire carrying system. In particular, a blower filter device can be secured on the base strap of the carrying system in a plurality of different positions due to the carrying system. As a result, different users of a blower filter system can arrange the blower filter device on their body in a position that is most favorable and comfortable for them, as a result of which the operation of the blower filter system is markedly facilitated for the user. In particular, blower filter systems with such carrying systems can be set for right-handed and left-handed persons in a simple manner without having to make any changes on the blower filter device or the carrying system.

The carrying system for a blower filter device of a blower filter system has a design similar to that of a backpack. The base strap is designed as a relatively stiff strap. The base strap may be formed from foam, especially multilayer foam with different degrees of hardness. Further, certain reinforcements may be provided in the base strap, preferably as plastic moldings. The base strap can be adapted to users of different sizes. Further, the shape of the base strap of the carrying system may have been adapted or may be adapted to both a male anatomy and a female anatomy.

Provisions are made in the carrying system for the securing system to have a guide element, which is secured to the base strap, wherein the guide element is designed to retain the blower filter device in the different positions. Further, provisions are made in the carrying system for the securing system to have a counter-guide element, which is guided displaceably on the guide element via at least one guide gap, and for the counter-guide element to have at least one securing system for securing the counter-guide element on the blower filter device. The counter-guide element is quasi an intermediate element, which can be secured on both the securing system of the carrying system and the blower filter device. The counter-guide element is designed here such that it moves along the securing system, especially along the guide element of the securing system and can be arranged, especially positioned, in the first position and the at least one second position on the securing system. It is especially preferable here if a force must be overcome to move the counter-guide element along the guide element of the securing system. It is ensured hereby that the counter-guide element and hence the blower filter device can only be displaced along the guide element if this is expressly desired by the user or if this is required by the situation. By implication, it is guaranteed by a certain resistance that must be overcome to move the counter-guide element along the guide element of the securing system that the counter-guide element makes possible a simple connection of the securing system of the carrying system with the blower filter device. The counter-guide element can be moved, especially displaced, via at least one guide gap on the guide element of the securing system. The guide element may be designed as a stiff guide element. However, it is also conceivable that the guide element is designed as a flexible guide element in at least one plane in order to approximately imitate the shape of the body of a user. The counter-guide element has at least one guide gap.

The at least one guide gap is preferably designed as a closed guide gap. The guide element must be passed through the at least one guide gap in case of a counter-guide element of such a design. This is possible if at least one end of the guide element is secured on the base strap of the carrying system after being threaded through the at least one guide gap. Such a carrying system is especially advantageous, because the counter-guide element cannot be separated any longer from the guide element, especially the guide belt, after threading through the guide element, especially a guide belt, and after securing the guide element to the base strap of the carrying system. This means that the counter-guide element is retained displaceably on the guide element, but it cannot be detached from the guide element without detaching the guide element from the base strap of the carrying system. This is of special significance especially because the counter-guide element and hence the blower filter device cannot be detached from the guide element and hence from the carrying system in certain use situations, for example, in crowded spaces, due to the impact of the blower filter device, which is secured on the counter-guide element. The blower filter device is retained especially securely on the carrying system due to a counter-guide element having such a design, which is essential for the user.

A guide element, which is designed as at least one guide belt, makes it possible to change the position of a blower filter device on the base strap of the carrying system in an especially simple manner. The guide element, especially the at least one guide belt, is designed to retain the blower filter device. On the other hand, the blower filter device can be displaced via the counter-guide element along the guide element and locked in a desired position.

The guide element, especially the guide belt, is secured to the base strap, especially detachably, at both of its ends. This makes it possible that a correspondingly designed blower filter device can be guided along the guide element between the secured ends of the guide element. The securing is designed as a detachable securing, so that detachment of the securing system and hence replacement of the guide element from the base strap are made possible. The securing may be effected, for example, via screw or snap-in elements. It is likewise conceivable that the securing is effected by a strong Velcro connection.

The counter-guide element has at least one securing system to secure the counter-guide element on the blower filter device. It is ensured hereby that the blower filter device can be secured on the counter-guide element, i.e., the intermediate element between the blower filter device and the securing system. Depending on the embodiment variant of the counter-guide element, the counter-guide element can be rigidly connected with the blower filter device via at least one securing system or it may be secured flexibly, i.e., movably, on the blower filter device in relation to said blower filter device. One advantage of a carrying system having such a design is that the carrying system has a modular design due to the counter-guide element. For example, the counter-guide element of the carrying system may be arranged first at a blower filter device, and the blower filter device can then be arranged such that it can be moved to the securing system of the carrying system via the counter-guide element of the carrying system. As an alternative hereto, the counter-guide element may be secured first on the securing system of the base strap and a blower filter device can be secured on the counter-guide element.

Due to the counter-guide element, the blower filter device can be easily uncoupled from the guide element or the securing system. The counter-guide element can be easily secured to the blower filter device via the securing system and the blower filter device can be easily secured to the counter-guide element via the securing system. A blower filter device can therefore be easily replaced from the carrying system, i.e., without changing the securing system of the carrying system.

Provisions may be made in an advantageous carrying system for the counter-guide element to be a carriage element displaceable on the guide element, especially on the at least one guide belt. A carriage element in the sense of the present invention is a component that can easily be displaced on the guide element and that can be additionally secured to a blower filter device via its at least one securing system and that can secure a blower filter device via its at least one securing system. The at least one guide gap of the carriage element is preferably designed such that the carriage element can slide easily along the guide element, especially on a guide belt, in order to be displaced between different positions on the guide element in a simple manner. The areas of the carriage element that form a guide gap may have surfaces with special sliding properties. In particular, the surfaces of at least some areas of the carriage element, which are associated with the at least one guide belt, may be round or arched. The counter-guide element or the carriage element preferably has two guide gaps, by which the guide element, especially the guide belt, is guided. The guide gap or guide gaps are designed and dimensioned here such that the guide element or guide belt can be guided accurately through the guide gap or guide gaps. In other words, the at least one guide gap and the guide element or guide belt are preferably designed and dimensioned such that the guide element or guide belt can be guided through the guide gap with a slight clearance in relation to the walls of the at least one guide gap. It is ensured hereby that the counter-guide element and hence the blower filter device secured to the counter-guide element are not seated loosely on the guide element or guide belt. At the same time, the guide element or guide belt is preferably secured on the base strap of the carrying system under such a tension that this will not flutter. This is enhanced by the counter-guide element or carriage element being designed as a plate, i.e., the counter-guide element or carriage element is designed as a plate. A carriage element designed as a plate has a rather flat design, so that a blower filter device can be retained guidably close to the base strap of the carrying system and hence close to the body of the user. It is ensured hereby that the blower filter device, which is arranged movably on the carrying system, will hardly limit the freedom of movement of a user. At the same time, it is ensured hereby that the counter-guide element and hence the blower filter device are not guided far away from the body of the user and thus they will not flutter about loosely. For example, a counter-guide element designed as a plate may have a guide gap each on two opposite sides, and at least one guide belt of the securing system of the carrying system can be passed through said guide gap. Projections, which are used to guide the at least one guide belt through the guide gaps in a simplified manner, may be provided at each guide gap inclined in relation to the plate. It is ensured hereby that the guide belt can be guided through, especially slid along, the guide gaps without getting caught or jammed.

The counter-guide element and the guide element are especially preferably designed and coordinated with one another such that displacement of the counter-guide element on the guide element is only made possible if a defined force is overcome, i.e., a relative motion of these two elements is made possibly only if a defined force is overcome. In other words, the counter-guide element can only be moved, especially displaced, along the guide element if a defined force, which is stronger than the force with which the counter-guide element is retained at the guide element, is applied for moving the counter-guide element.

In particular, the counter-guide element and the guide element are designed and coordinated with one another such that these form a frictionally engaged connection with one another. A force that is stronger than the frictional force between the counter-guide element and the guide element must be applied to move the counter-guide element and hence the blower filter device along the guide element. If the guide element is designed as a guide belt, the counter-guide element is retained on the guide belt in a frictionally engaged manner. It is ensured hereby that the blower filter device is retained in a desired position on the securing system. The counter-guide element preferably has guide means, which make it possible that the counter-guide element can be retained in the desired position on the guide element of the securing system of the carrying system while developing a frictional engagement. Especially the at least one guide gap of the counter-guide element is used as the guide means. The clearance between the guide belt and the at least one guide gap can be kept so small that a frictional force must be overcome when displacing the counter-guide element on the guide element.

The counter-guide element especially preferably has as a guide element two guide gaps, through which a guide element designed as a guide belt is passed. The guide gaps and the guide belt are designed here such that the guide belt is retained in the guide gaps in a frictionally engaged manner. Displacement of the counter-guide element along the guide belt is only possibly now if a force that is stronger than the frictional force between the guide belt and the guide gaps is applied. The counter-guide element and hence the blower filter device are arranged in such an embodiment of the carrying system such that a frictionally engaged connection is formed on the guide belt of the securing system. A user can eliminate the frictional connection and displace the counter-guide element and hence the blower filter device along the guide belt by applying a force. One advantage of such a carrying system is that the blower filter device may be displaced by itself in certain situations, for example, when the user is passing through a narrow gap and the blower filter device is pressed against a wall, which forms the gap. The blower filter device may be displaced by the force acting on the blower filter device from the wall during the passage through the gap and the user can pass through the gap more easily, without having to displace the blower filter device himself.

According to another preferred embodiment of the present invention, provisions may be made, in addition or as an alternative, in a carrying system for the counter-guide element to have a securing element for locking the counter-guide element in the first position or in the at least one second position on the guide element. The securing element is preferably designed such that it can lock, together with retaining elements of the guide element, the counter-guide element and hence the blower filter device arranged on the counter-guide element in the corresponding, desired positions on the securing system of the carrying system. For example, the securing element may be designed as a projection, which projects from the counter-guide element, especially from the carriage element designed as a plate, and which can mesh with corresponding depressions of the guide element, for example, holes in the guide belt. For example, a securing element designed as a projection may have the shape of a round pin. As an alternative hereto, the securing element may be designed as a magnet or as a magnetizable area, which interacts with a magnetic retaining element on the base strap or on the securing system, especially on the guide element, in defined positions. It is guaranteed by such a securing element that the counter-guide element and hence the blower filter device can be retained securely on the securing system of the carrying system in the corresponding positions. The securing element ensures, in particular, that the counter-guide element and hence the blower filter device cannot be twisted or pivoted in a defined position. According to another embodiment variant of a carrying system, the securing element may be formed by one side of the counter-guide element designed preferably as a plate. The side of the counter-guide element acts in this case as a frictional contact for the guide element, which element is preferably designed as a guide belt. In particular, the counter-guide element and the guide element may be designed such that these can be jammed with one another when a desired position of the counter-guide element is reached on the guide element, and the side of the counter-guide element facing the guide element is clamped against the guide element, especially against the guide belt. The counter-guide element and, as a result, the blower filter device are locked by the frictional engagement generated hereby in the corresponding position on the guide element of the securing system. If, for example, the counter-guide element is already guided on the guide element in a frictionally engaged manner, very rigid locking of the blower filter device on the securing system can be additionally achieved by the guide element, designed especially as a guide belt, being jammed between the counter-guide element and the blower filter device when the counter-guide element is secured on the blower filter device.

Preferred is, further, a carrying system in which the counter-guide element has at least one snap-in element for locking on the blower filter device. As a result, simple securing of the counter-guide element on the blower filter device or vice versa can be achieved if the blower filter device is pivoted onto the counter-guide element.

Especially preferred is a carrying system that is characterized in that the securing system of the counter-guide element has a hinge device for the pivotable securing of the counter-guide element on the blower filter device or of the blower filter device on the counter-guide element, i.e., the counter-guide element can be arranged pivotably on the blower filter device via the hinge device.

A securing system of a counter-guide element, which is designed in this manner, is especially advantageous if the counter-guide element is designed as a carriage element, especially as a plate-like (plate) carriage element. A guide element of the securing system, designed as a guide belt, can thus be passed through correspondingly designed guide gaps on two opposite sides of the counter-guide element. The guide belt led past on one side of the counter-guide element can be clamped on the blower filter device by pivoting the counter-guide element in the direction of the blower filter device. It is ensured hereby that the counter-guide element can be locked in the respective desired position along the guide element, especially along the guide element designed as a guide belt. At least one snap-in element, by which the counter-guide element can be secured on the blower filter device, is preferably provided on the side of the counter-guide element located opposite the hinge device. It is ensured in this secured position, i.e., in the position in which the snap-in element is snapped in on the blower filter device, that the guide element designed as a guide belt is clamped between the counter-guide element and one side of the housing of the blower filter device. The counter-guide element and hence the blower filter device are locked by this frictional engagement relative to the guide element of the securing system. The counter-guide element can be pivoted out of the secured position by simply loosening the locking, as a result of which the motion of the counter-guide element on the guide element, i.e., on the guide belt, is released. Another position, in which the blower filter device shall be fixed on the carrying system, can be reached by a subsequent displacement of the counter-guide element along the guide belt.

The hinge device may be, for example, a cylindrical section open toward one side on the counter-guide element, into which at least one axis of the blower filter device can be snapped rotatably. This means that the at least one axis and the cylindrical section open toward one side are designed such that the axis is fixed rotatably in the section after securing the at least one axis in the section. At the same time, a nonpositive and positive-locking connection is effected between the at least one axis and the open section. The cylindrical section open toward one side may also be part of the blower filter device. The counter-guide element has at least one axis in this case The hinge device of the securing system is designed such that the blower filter device can be secured pivotably on the counter-guide element. Further, the hinge device of the securing system is designed such that the blower filter device can again be detached from the counter-guide element by applying a defined force in order to replace, for example, a defective blower filter device with a properly functioning blower filter device.

According to a second aspect of the present invention, the object is accomplished by a blower filter device for a blower filter system, having at least one filter, a fan impeller arranged in a fan housing, a motor for driving the fan impeller as well as a control unit for actuating the motor and for processing device-specific parameters of the blower filter device. The blower filter device is characterized in that this has at least one locking element for detachably securing the blower filter device on the counter-guide element of a carrying system according to the first aspect of the present invention.

A blower filter device designed in this manner for a blower filter system makes possible, in conjunction with a carrying system that is designed according to the first aspect of the present invention, a high flexibility in handling a blower filter system in a cost-effective and simple manner.

The at least one locking element makes possible the simple and at the same time detachable securing of the blower filter device on the counter-guide element of a carrying system or vice versa. The locking element may be designed, for example, as a snap-in device, especially as a snap-in seat, for securing the at least one securing system or the at least one securing system of the counter-guide element, which securing system is designed as a snap-in element. Simple securing of the blower filter device on the counter-guide element of a carrying system is possible as a result. For example, the snap-in device may be an undercut or a projection.

According to a preferred variant of the present invention, provisions may be made in a blower filter device for this blower filter device to have a depression for receiving the counter-guide element, especially in a positive-locking manner. The depression may be designed such that it also receives, especially encloses, a guide element, especially guide belt, of the securing system of a carrying system according to the present invention, which said guide element is threaded through the at least one guide gap. It is guaranteed hereby that the blower filter device secured on a carrying system is arranged close to the body of a user during use. The depression is preferably provided over the entire width of a blower filter device.

According to another preferred variant of the present invention, provisions may be made in a blower filter device for this to have a hinge element in order to bring about pivoting of the blower filter device on the counter-guide element together with the hinge device of the counter-guide element, i.e., the blower filter device can be arranged pivotably, via the hinge element, on the counter-guide element in cooperation with the hinge device of the counter-guide element. In particular, the hinge element may be designed and arranged on the blower filter device such that the counter-guide element will be or is received in the depression of the blower filter device when pivoting the blower filter device in the direction of the counter-guide element and subsequently securing the blower filter device on the counter-guide element.

The hinge element of the blower filter device may be designed, for example, as at least one axis. This axis can be snapped in rotatably on the counter-guide element into a hinge device, which is designed as a cylindrical section, which is open toward one side. This means that the at least one axis and the cylindrical section open toward one side are designed such that the axis is fixed rotatably in the section after securing the at least one axis in the section. The snapping in is preferably effected in a non-positive and positive-locking manner. As an alternative hereto, the hinge element of the blower filter device may be designed as a cylindrical section open toward one side. The counter-guide element has at least one axis in this case. The hinge element of the blower filter device is designed such that by applying a defined force, the blower filter device can again be detached from the counter-guide element in order to replace, for example, a defective blower filter device with a properly functioning blower filter device.

According to a third aspect of the present invention, the object is accomplished by a blower filter system having a blower filter device, a headpiece, a connection tube, which connects the blower filter device and the headpiece with one another in a fluid-communicating manner, wherein the blower filter system has a carrying system according to the first aspect of the present invention, especially according to one of the claims 1 through 8. A blower filter system of such a design has high flexibility in handling, i.e., a user of the blower filter system can arrange the blower filter device in different positions on the carrying system in a cost-effective and simple manner, so that the user can set the position of the blower filter device that is optimal for him on the carrying system. At the same time, simple replacement of a blower filter device from the carrying system is possible in such a blower filter system.

As an alternative to the above-described blower filter system, a blower filter system, having a blower filter device, a headpiece and a connection tube, which connects the blower filter device and the headpiece with one another in a fluid-communicating manner, in which blower filter system the blower filter device is designed according to the second aspect of the present invention is advantageous.

The above invention will be explained in more detail on the basis of the drawing figures attached. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view a user with a blower filter system, which is designed according to the design principle according to the present invention;

FIG. 2 is a perspective view of a blower filter device, which is arranged in a second position on a carrying system for the blower filter device;

FIG. 3 is a perspective view of the blower filter device according to FIG. 2 in a first position on the carrying system for the blower filter device;

FIG. 4 is a view of a carrying system with a guide element designed as a guide belt;

FIG. 5 is a perspective view of a counter-guide element of a carrying system according to the present invention, which can be secured to a blower filter device;

FIG. 6 is a view showing different side views and a top view of the counter-guide element according to FIG. 5;

FIG. 7 is a perspective view of the counter-guide element according to Figure, which is secured on a blower filter device;

FIG. 8 is a side view of a guide belt of a securing system of a carrying system according to the present invention, which said guide belt is threaded through guide gaps of the counter-guide element; and

FIG. 9 is a blower filter device of a blower filter system, which is designed according to the design principle according to the present invention.

### DESCRIPTION OF THE PREFERRED EMBODIMENTS

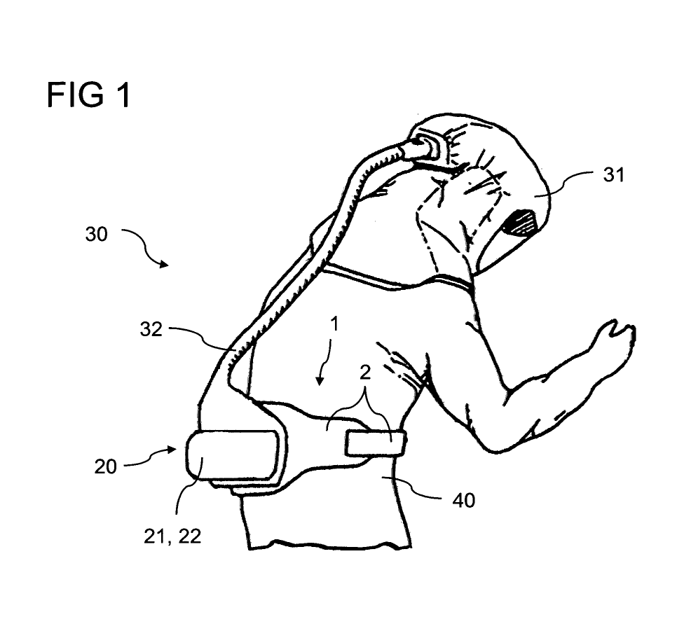

Referring to the drawings, elements having the same function and mode of operation are always designated by the same reference numbers in FIGS. 1 through 9.

FIG. 1 schematically shows a user with a blower filter system 30, which is designed according to the design principle according to the present invention. The blower filter system 30 has a blower filter device 20, a headpiece 31, which may be designed as a hood or s a mask, and a connection tube 32, which connects the blower filter device 20 and the headpiece 20 with one another in a fluid-communicating manner. The blower filter device 20 has at least one filter 21 and an invisible fan impeller arranged in a fan housing 22. Further, the blower filter device 20 advantageously has a motor (not shown) for driving the fan impeller as well as a control unit (not shown) for actuating the motor and for processing device-specific parameters of the blower filter device 20. Further, the blower filter system 30 has a carrying system 1, on which the blower filter device 20 is mounted movably. The carrying system 1 has a base strap 2, which is designed such that it can sit on the hip of the user's body 40.

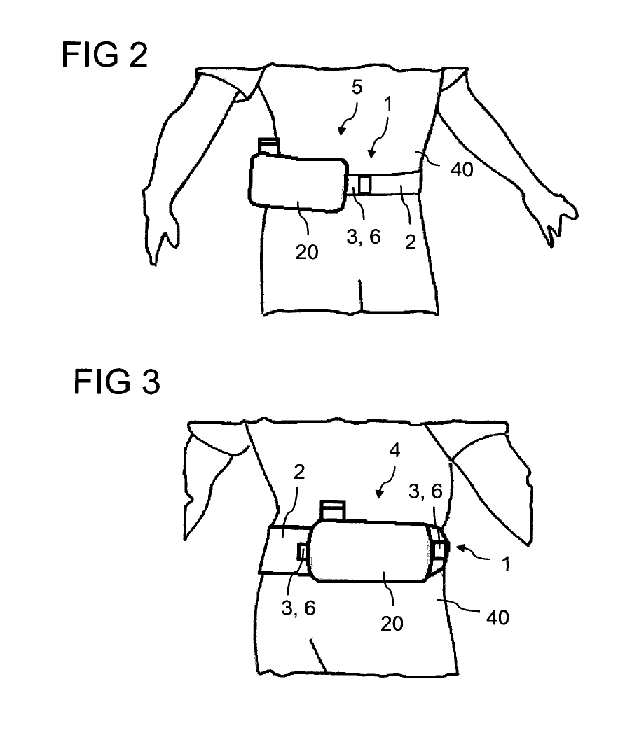

FIGS. 2 and 3 show in a perspective view a blower filter device 20, which is arranged on a carrying system 1, wherein the blower filter device 20 is positioned in FIG. 2 in a second position 5 on the carrying system 1, whereas the blower filter device 20 is arranged in FIG. 3 in a first position 4 on the carrying system 1. The first position 4 of the blower filter device 20 on the carrying system 1, which position is shown in FIG. 3, represents the usual carrying position for a blower filter device 20 of a blower filter system 30. It is disadvantageous here that a user cannot detect by touch or recognize control elements of the blower filter device 20 or display elements of the blower filter device 20. The blower filter device 20 can be flexibly displaced by means of a securing system 3, which is secured to the base strap 2 of the carrying system 1, so that the blower filter device 20 can be displaced into at least one second position 5, see FIG. 2. In this second position 5, as is shown in FIG. 2, the blower filter device 20 is positioned laterally on the body 40 of the user, so that the user can easily actuate control elements of the blower filter device 20 and read a display of the blower filter device 20. The handling of the blower filter system 30 is markedly simplified hereby compared to a blower filter system in which the blower filter device can only be secured in one position on the base strap 2 of the carrying system 1.

The carrying system 1 sits in a fixed and defined position on the body 40 of the user. A blower filter device 20 can be secured to the securing system 3 of the carrying system 1. The blower filter device 20 is secured on the securing system 3 of the carrying system 1 such that the blower filter device can be displaced horizontally, i.e., along a guide element 6 of the securing system 3. The blower filter device 20 is located on the back of the user in the area of the lumbar spine, see first position 4 in FIG. 3, during normal use of the blower filter device 30. If it is necessary to change the position of the blower filter device 20, the blower filter device 20 can be moved into a lateral position, i.e., a second position 5, as is shown in FIG. 2, by displacing same manually. The motion of the blower filter device 20 between the first position 4 and the at least one second position 5 is preferably effected manually. The displacement of the blower filter device 20 along the guide element 6 of the securing system 3 of the carrying system 1 may be carried out during the current operation and when the blower filter device 20 is stopped.

A plurality of advantages arise from this compared to the prior-art carrying systems. The blower filter device 20 can be pushed forward for better operation. In narrow passageways or during use in the dorsal position, the user can displace the blower filter device 20. The hindrance caused by the blower filter device 20 can be minimized hereby. Further, the user's clothing can be spared due to the use of such a blower filter device 20 displaceably on the carrying system 1.

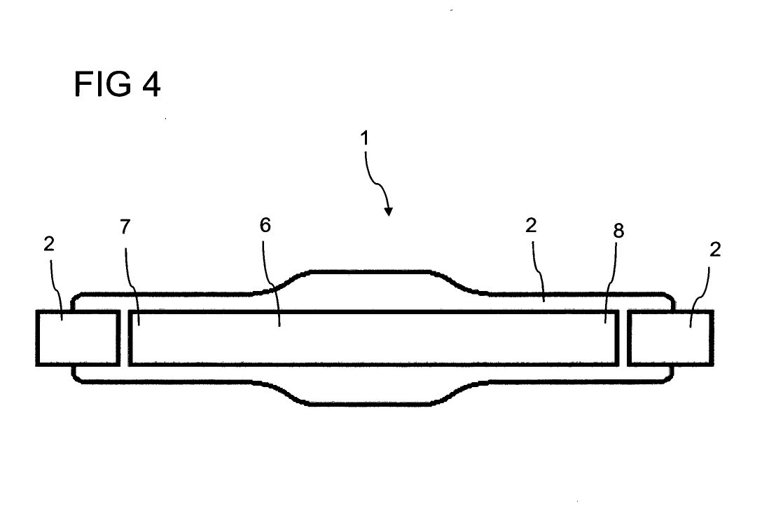

FIG. 4 schematically shows a view of a carrying system 1 with a guide element 6 designed as a guide belt. The first end 7 of the guide belt 6 and the second end 8 of the guide belt 6 are secured on the base strap 2 of the carrying system 1. At least one end 7, 8 is now secured detachably on the base strap 2. The guide belt 6 is free between the ends 7, 8, so that a counter-guide element 10 of a carrying system 1 can be guided at this displaceably.

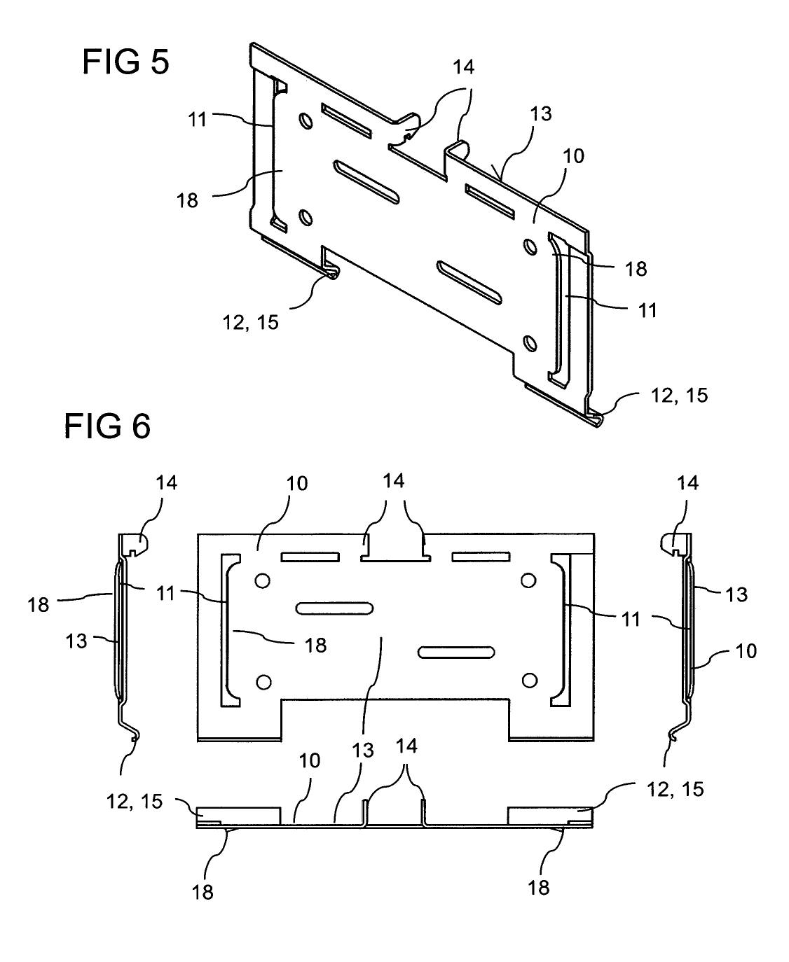

FIG. 5 shows a perspective view of a counter-guide element 10 of a carrying system 1 according to the present invention, which can be secured on a blower filter device 20. The counter-guide element 10 is designed as a plate-like carriage element. The counter-guide element 10 can be secured pivotably on a housing or on a hinge element 25 of a blower filter device 20 via the securing systems 12 designed as hinge device 15. A locking element or a snap-in device 23 on the blower filter device 20 makes it possible to lock the counter-guide element 10 on the blower filter device 20. A guide element 6 designed as a guide belt can be passed through the guide gaps 11. The counter-guide element 10 and the guide element 6 of the securing system 3, which guide element 6 is not shown, are designed and coordinated with one another such that a relative motion of these two elements 6, 10 is only possible when a defined force is overcome, i.e., the guide belt 6 is passed through the guide gaps 11 while forming a frictionally engaged connection. The counter-guide element 10 and hence the blower filter device 20 can only be displaced along the guide belt 6 if a force that is stronger than the frictional force between the guide gaps 11 and the guide belt 6 is applied to the blower filter device 20 for displacement. It is guaranteed hereby in a simple and reliable manner that the blower filter device 20 cannot be displaced on the securing system 3 of the carrying system 1 at random, so that a counter-guide element 10 of a carrying system 1 can be guided displaceably on this.

A lateral surface of the counter-guide element 10 may additionally act as a securing element 13, so that the guide belt 6 is jammed between the counter-guide element 10 and the housing of the blower filter device 20 in a snapped-in position of the counter-guide element 10 on a blower filter device 20. Positioning of a blower filter device 20 on a guide element 6 of a securing system 3 of the carrying system 1, which said guide element 6 is designed as a guide belt, is likewise guaranteed hereby.

FIG. 6 shows once again different views of the counter-guide element 10 according to FIG. 5. A guide belt 6 of a securing system 3 of a carrying system 1 can be pulled through the guide gaps 11 of a counter-guide element 10 and subsequently secured on the base strap 2 of the carrying system 1. Secure, especially frictionally engaged guiding of the counter-guide element 10 on the guide belt 6 of the securing system 3 is guaranteed hereby. The counter-guide element 10 can be secured on a blower filter device 20 via the snap-in elements 14 of the counter-guide element 10.

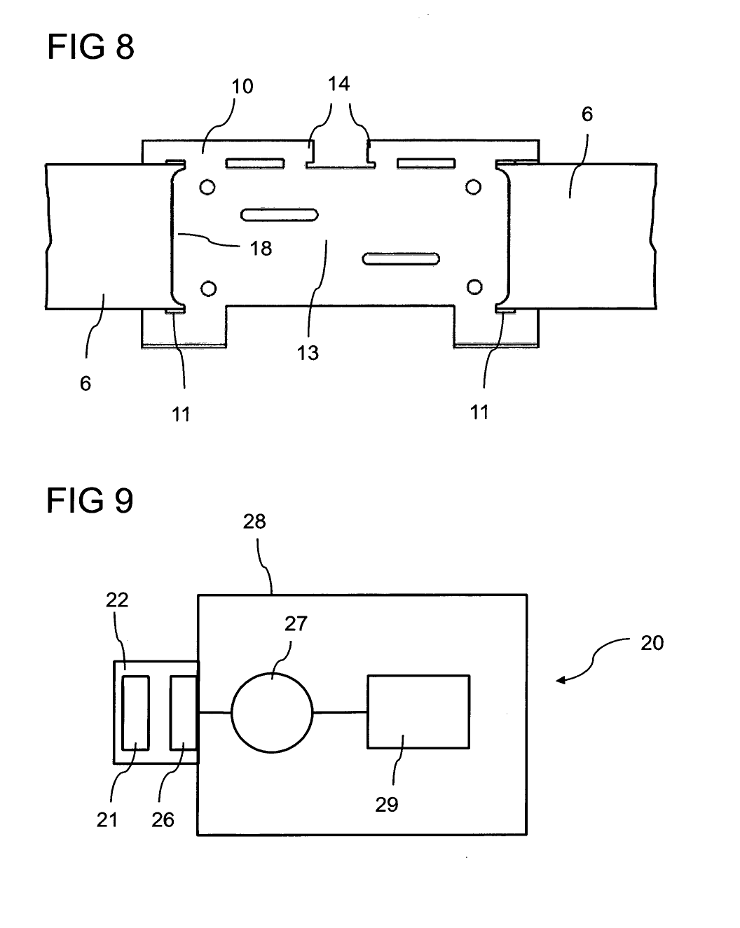

The counter-guide element 10 is designed as a displaceably mountable, plate-like carriage element. This is a component that can easily be displaced on the guide element 6. The guide gaps 11 of the carriage element 10 are designed such that the carriage element 10 can slide easily along a guide element 6, especially on a guide belt, in order to be displaced between different positions 4, 5 on a guide element 6 in a simple manner. The areas of the carriage element 10 that form the guide gaps 11 may have surfaces possessing special sliding properties. Projections, which are arranged inclined in relation to the plate-like carriage element 10 and which are used for the simplified guiding of the at least one guide belt 6 through the guide gaps 11, may be provided. It is ensured hereby that the guide belt 6 can be guided through, especially slide along, the guide gaps 11 without getting caught or jamming. The projections may be round or arched projections. The two guide gaps 11, through which the guide element 6, especially the guide belt, is passed, are arranged close to the lateral ends of the counter-guide element 10. The guide gaps 11 are designed and dimensioned such that the guide belt 6 can be passed exactly through the guide gaps 11, see FIG. 8. This means that the guide belt 6 can be passed through the guide gaps 11 with a slight clearance in relation to the walls of said guide gaps 11. It is ensured hereby that the counter-guide element 10 and hence the blower filter device 20 secured on the counter-guide element 10 are not seated loosely on the guide belt 6. The guide belt 6 is preferably secured on the base strap 2 of the carrying system 1 with such a tension that this will not flutter.

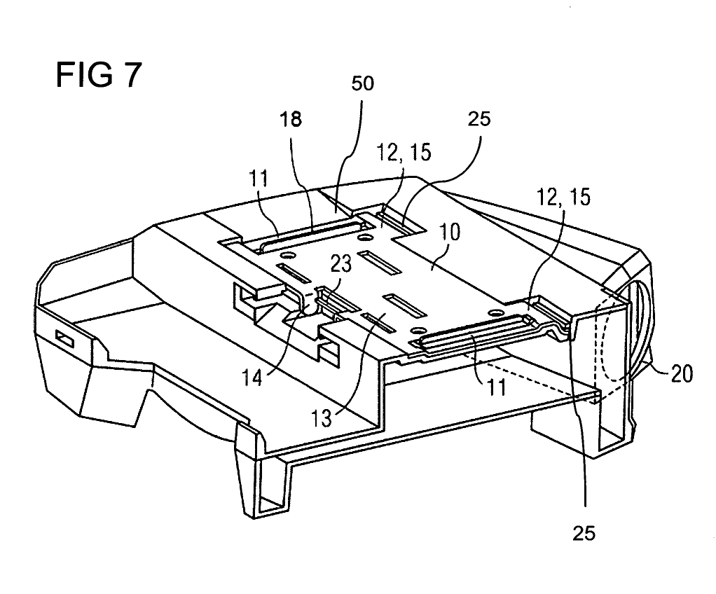

FIG. 7 shows a counter-guide element 10, as is shown in FIGS. 5 and 6, in a secured position on a blower filter device 20. A snap-in element 23, here in the form of a rod, with which the hook-shaped snap-in elements 14 of the counter-guide element 10 can mesh, is arranged on the blower filter device 20. The blower filter device 20 can easily be secured as a result on the counter-guide element 10 when this is seated on the blower filter device 20, especially in the depression 50 of the blower filter device 20 that is provided specifically for the counter-guide element 10. The depression 50 is used especially to receive the counter-guide element 10 on the blower filter device 20 in a positive-locking manner. The depression is designed such that it also receives, especially encloses, a guide element 6 threaded through the guide gaps 11, especially a guide belt 6, of the securing system 3 of a carrying system 1 according to the present invention. It is guaranteed hereby that the blower filter device 20 secured on a carrying system 1 is arranged close to the body of a user during use. The depression is a trough-shaped depression and extends over the entire width of the blower filter device 20.

FIG. 9 schematically shows a blower filter device 20 of a blower filter system 30, which is designed according to the design principle according to the present invention. The blower filter device 20 has a fan impeller 26, which is arranged in a fan housing 22 and which is driven by a motor 27. A filter 21, which purifies the ambient air drawn in by the fan impeller 26, is arranged upstream of the fan impeller 26. A control unit 29, which is used, further, to process device-specific parameters of the blower filter device 1, is provided for actuating the motor 27. The blower filter device 1 has, further, a housing 28, in which the components of the blower filter device 1 are arranged.

This explanation of the embodiments describes the present invention only within the framework of examples. Individual features of the embodiments, if technically meaningful, may, of course, be freely combined with one another without going beyond the scope of the present invention. While specific embodiments of the invention have been shown and described in detail to illustrate the application of the principles of the invention, it will be understood that the invention may be embodied otherwise without departing from such principles.

1. A carrying system for a blower filter device of a blower filter system, the carrying system comprising:
a base strap for arranging the carrying system on a body of a user; and
a securing system on the base strap for securing the blower filter device in a first position and in at least one second position on the base strap, wherein the second position is different from the first position, wherein the securing system comprises:
a guide element, which is secured on the base strap, wherein the guide element is designed to retain the blower filter device in the different positions; and
a counter-guide element, which is guided displaceably on the guide element via at least one guide gap, the counter-guide element comprising at least one securing system for securing the counter-guide element on the blower filter device.

2. A carrying system in accordance with claim 1, wherein the counter-guide element is a carriage element mounted displaceably on the guide element wherein the guide element comprises at least one guide belt.

3. A carrying system in accordance with claim 1, wherein the counter-guide element comprises a plate.

4. A carrying system in accordance with claim 1, wherein the counter-guide element and the guide element are designed such that a displacement of the counter-guide element on the guide element is only made possible when a defined force is overcome.

5. A carrying system in accordance with claim 1, wherein the counter-guide element further comprises a securing element for locking the counter-guide element in the first position or in the at least one second position on the guide element.

6. A carrying system in accordance with claim 1, wherein the counter-guide element further comprises at least one snap-in element for snapping in on the blower filter device.

7. A carrying system in accordance with claim 1, wherein the securing system comprises a hinge device pivotably securing the counter-guide element on the blower filter device or the blower filter device on the counter-guide element.

8. A blower filter device for a blower filter system, the blower filter device comprising:
a fan housing;
at least one filter;
a fan impeller arranged in the fan housing;
a motor for driving the fan impeller;
a control unit for actuating the motor and for processing device-specific parameters of the blower filter device;
at least one locking element; and
a carrying system comprising:
a base strap for arranging the carrying system on a body of a user;
a securing system on the base strap for securing the blower filter device in a first position and in at least one second position on the base strap, wherein the second position is different from the first position, wherein the securing system comprises:
a guide element, which is secured on the base strap, wherein the guide element is designed to retain the blower filter device in the different positions; and
a counter-guide element, which is guided displaceably on the guide element via at least one guide gap, the counter-guide element comprising at least one securing system for securing the counter-guide element on the blower filter device, wherein the at least one locking element is for detachably securing the blower filter device on the counter-guide element of the carrying system.

9. A blower filter device in accordance with claim 8, wherein the blower filter device has a depression for receiving, in a positive-locking manner, the counter-guide element.

10. A blower filter device in accordance with claim 8, further comprising at least one hinge element in order to bring about pivoting of the blower filter device on the counter-guide element together with the hinge device.

11. A blower filter system comprising:
a blower filter;
a headpiece; and
a connection tube, which connects the blower filter device and the headpiece with one another in a fluid-communicating manner, wherein the blower filter system has a carrying system comprising:
a base strap for arranging the carrying system on a body of a user;
a securing system on the base strap for securing the blower filter device in a first position and in at least one second position on the base strap, wherein the second position is different from the first position, wherein the securing system comprises:
a guide element, which is secured on the base strap, wherein the guide element is designed to retain the blower filter device in the different positions; and
a counter-guide element, which is guided displaceably on the guide element via at least one guide gap, the counter-guide element comprising at least one securing system for securing the counter-guide element on the blower filter device, wherein the at least one locking element detachably secures the blower filter device on the counter-guide element.

12. A blower filter system comprising:
a blower filter device comprising a fan housing, at least one filter, a fan impeller arranged in the fan housing, a motor for driving the fan impeller, a control unit for actuating the motor and for processing device-specific parameters of the blower filter device, and at least one locking element;
a headpiece; and
a connection tube (32), which connects the blower filter device and the headpiece with one another in a fluid-communicating manner, wherein the blower filter device has a carrying system comprising:
a base strap for arranging the carrying system on a body of a user;
a securing system on the base strap for securing the blower filter device in a first position and in at least one second position on the base strap, wherein the second position is different from the first position, wherein the securing system comprises:
a guide element, which is secured on the base strap, wherein the guide element is designed to retain the blower filter device in the different positions; and
a counter-guide element, which is guided displaceably on the guide element via at least one guide gap, the counter-guide element comprising at least one securing system for securing the counter-guide element on the blower filter device, wherein the at least one locking element detachably secures the blower filter device on the counter-guide element.

13. A blower filter system in accordance with claim 12, wherein the counter-guide element is a carriage element mounted displaceably on the guide element wherein the guide element comprises at least one guide belt.

14. A blower filter system in accordance with claim 12, wherein the counter-guide element comprises a plate.

15. A blower filter system in accordance with claim 12, wherein the counter-guide element and the guide element are designed such that a displacement of the counter-guide element on the guide element is only made possible when a defined force is overcome.

16. A blower filter system in accordance with claim 12, wherein the counter-guide element further comprises a securing element for locking the counter-guide element in the first position or in the at least one second position on the guide element.

17. A blower filter system in accordance with claim 12, wherein the counter-guide element further comprises at least one snap-in element for snapping in on the blower filter device.

18. A blower filter system in accordance with claim 12, wherein the securing system comprises a hinge device pivotably securing the counter-guide element on the blower filter device or the blower filter device on the counter-guide element.

19. A blower filter system in accordance with claim 12, wherein the blower filter device has a depression for receiving, in a positive-locking manner, the counter-guide element.

20. A blower filter system in accordance with claim 12, further comprising at least one hinge element in order to bring about pivoting of the blower filter device on the counter-guide element together with the hinge device.
